(19) United States
(12) Patent Application Publication
(10) Pub. No.: US 2008/0209481 A1
(43) Pub. Date: Aug. 28, 2008

(54) Directly access attached video on demand delivery

(75) Inventor: Tim Barrett, Kanata (CA)

Correspondence Address: KRAMER & AMADO, P.C., 1725 DUKE STREET, SUITE 240, ALEXANDRIA, VA, 22314, US

(73) Assignee: ALCATEL-LUCENT, Paris (FR)

(21) Appl. No.: 11/710,493

(22) Filed: Feb. 26, 2007

(51) Int. Cl. H04N 7/173

(52) U.S. Cl. 725/91

(57) ABSTRACT

An apparatus and method for managing requests for video on demand media data for effecting VoD stream delivery, including an interface for receiving data requests addressed for processing by a particular data request service device, an agent operatively coupled to the interface and configured for selecting which of a number of different data request service devices to send the request, irrespective of the device to which the request is addressed, and/or a module for determining if a received request can be serviced by a preferred request service device based on its ability to service the request. In some embodiments, when the preferred device is capable of servicing the request, the request is directed to that device, otherwise to another device, possibly the device to which the request is originally addressed. In some embodiments, the preferred request service device resides at an access node for delivering media services to subscriber equipment.

### BACKGROUND OF THE INVENTION

This invention relates generally to managing requests for video on demand (VoD) titles, and in particular, but not limited to delivering specific VoD titles that have been cached in the network to a client.

In existing IP (Internet Protocol) TV networks, Video On Demand services from one or more service providers are transmitted over the network to various access nodes located in residential or commercial neighborhoods and which provide a connection to subscriber equipment.

To reduce the bandwidth required to transport video data, the data is typically compressed prior to transmission by a video compression algorithm such as the MPEG2 standard of the International Telecommunication Unions Moving Pictures Experts. For Video on Demand Services, this data is typically transmitted across the carrier network.

### SUMMARY OF THE INVENTION

In a VoD transmission service, the closer the VoD content can be moved to the end user, the lower the cost of the delivery.

Thus, according to various exemplary embodiments, there is provided an apparatus comprising an interface for receiving VoD request addressed for processing by and to a predetermined entity, and an agent operatively coupled to the interface and being configured for directing said VoD request to an entity other than said predetermined entity for processing said VoD request. When utilized in an application involving VoD data, the agent can be referred to interchangeably as a VoD agent.

In this exemplary arrangement, an agent intercepts VoD request that is addressed for processing by a predetermined entity and has the ability to redirect the VoD request to another entity for processing the VoD data. This arrangement allows VoD request to be processed by a particular entity without the device from which the VoD request is transmitted needing to specifically address the VoD request to that particular entity. Therefore, redirection of the VoD request by the agent and processing of the VoD request by the other entity can both be transparent to the device from which the VoD request is transmitted.

In this exemplary arrangement, the agent and the other entity can operate entirely independently of the predetermined entity to which the VoD request is addressed, and therefore operation of the agent and the other entity may be transparent to that predetermined entity. This exemplary arrangement also removes the need for the agent to be explicitly identified to any other device, such as the device to which the request is addressed or a system for managing that device or in which the apparatus may operate.

In various exemplary embodiments, the agent is adapted to redirect the VoD request to the other entity and not transmit the VoD request to the predetermined entity.

In various exemplary embodiments, the agent is adapted to determine an operation to be performed on the VoD request by the predetermined entity and to select the other entity based on its ability to perform the determined operation.

In various exemplary embodiments, the VoD request comprises a request for VoD data to be provided by the predetermined entity. For example, in various exemplary embodiments the request for VoD data comprises a request for a Video On Demand title, a portion of a title, or a portion of VoD data that was lost in a previous transmission.

Various exemplary embodiments include a module for selecting from a plurality of other entities, an entity to which to direct the VoD request.

Various exemplary embodiments further comprise a module for determining whether to direct the VoD request to the predetermined entity or to the other entity based on one or more predetermined criteria.

In various exemplary embodiments, the predetermined criteria comprises any one or more of (1) the status of the predetermined entity (for example its operational status), (2) the status of each other entity (for example their operational status) and (3) where the data includes a request for VoD data, whether the predetermined entity or each other entity has the requested data.

In various exemplary embodiments, the predetermined criteria comprises any one or more of (1) the available egress bandwidth of an entity, (2) an egress capacity of an entity, (3) an ingress capacity of an entity, (4) a processing load of an entity, and (5) the number of requests received by an entity, and the load on a network element, e.g. an access node or other node, for example a node where the entity is located.

In various exemplary embodiments, the address in the received data comprises a communication network address, for example an IP address, the address of an application (e.g. IP port address) and a media access control (MAC) address.

Also various exemplary embodiments include a first interface for receiving requests for VoD data from a device; a module for determining if a received request can be serviced by a predetermined request service device; and a second interface for outputting the received request to another request service device if the module determines that the predetermined request service device cannot service the request.

According to the foregoing, flexibility is provided in a system which is capable of handling VoD requests by enabling the device which services the request to be selected from a plurality of different service request devices based on their ability to handle the request. Thus for example, the predetermined request service device may be a preferred request service device for handling data requests, in which case the module may determine that the request is to be handled by that request service device if it is able to do so. However, if in this example the module determines that the preferred request service device is unable to handle the request, the module causes the request to be forwarded to another request service device.

Various exemplary embodiments are implemented in a communication network for transporting media data to different subscribers to reduce the traffic load on the network. For example, in various exemplary embodiments, both the predetermined request service device and the other request service device comprise devices for providing subscriber equipment with video data in the stead of a network based server, with the predetermined request service device being situated closer to the subscriber equipment than the other device.

In various exemplary embodiments, the predetermined request service device is situated at an edge or aggregation node of the network, at an access node connected to individual subscriber premises, or a node between an aggregation node and access node, and the other request service device is situated more remotely, for example at or near a network edge node, or in the network core. In various exemplary embodiments, the module determines whether the predetermined request service device which is closer to the subscriber equipment can handle a received request, and if so, enables that request service device to service the request. If the request service device can handle the request, the data load on the network is reduced as fewer network resources will be involved in servicing the request due to the proximity of the request service device to the subscriber equipment.

On the other hand, in various exemplary embodiments the module provides a mechanism by which the request can alternatively be handled by another request service device if the predetermined request service device is unable to service the request, so that the request can still be handled by the system even when the preferred request service device is unable to do so, for example, because that device does not have the requested data, or does not have the capacity (e.g. egress bandwidth) to transmit the required unicast video (or other requested) data. In this manner, various exemplary embodiments allow the capacity of the predetermined request service device for handling data requests to be limited, and therefore the device to be implemented possibly more simply and at a lower cost.

Various exemplary embodiments comprise a selector for selecting for the determination by the module, requests for data addressed for servicing by a device other than the predetermined request service device. In various exemplary embodiments, the selector automatically intercepts data requests addressed to another device so that the module can make a determination of whether the predetermined request service device can service the request.

In various exemplary embodiments, if the module determines that the predetermined request service device can handle the request, it enables that device to do so and may or may not also forward the request to the device to which the request is addressed. In various exemplary embodiments, if the predetermined request service device can handle a request, it does so instead of the request service device to which the request is addressed and therefore operates in a manner which is transparent to the requesting device (e.g. subscriber equipment), since there is no need to address the request to the predetermined request service device. Similarly, in various exemplary embodiments, if the request is forwarded by the module to the device addressed in the request, the intercepting function of the apparatus is transparent to that end device.

Various exemplary embodiments include a selector for identifying and selecting requests for VoD data for the determination by the module from other signals received by the first interface. Thus for example, the selector may provide a filtering function for identifying VoD requests from other signals and may be adapted to pass only VoD requests to the module to increase the speed at which VoD requests can be handled.

Various exemplary embodiments include a device for including in a VoD request, an identifier recognizable by the selector that the request is to be processed by the module. For example, a device may be provided for including a label or tag in data requests to assist in identifying those requests for which a determination needs to be made by the module as to whether the request can be handled by one particular data service request device or another.

In various exemplary embodiments, the module is adapted to determine if a received request can be serviced by the predetermined request servicing device according to one or more predetermined criteria. In various exemplary embodiments, the predetermined criteria includes any one or more of (1) that the request cannot be serviced if the requested data is not available at the predetermined request service device, (2) that, even if the data is available at the predetermined request service device, the device cannot service the request based on the status of the device, and (3) that the request cannot be serviced based on a predetermined status of the device. For example, in various exemplary embodiments, the module determines that the request cannot be serviced if there is insufficient bandwidth available for transmitting the requested VoD data to the requesting device or that the VoD request servicing device has a fault, a malfunction or has failed.

In various exemplary embodiments, the request for data is a request for popular video and/or audio data. In various exemplary embodiments, the apparatus detects popular Video On Demand titles and automatically caches those titles.

In various exemplary embodiments, the predetermined request service device comprises an interface for transmitting data flow data from the storage device to a device for using the data. Various exemplary embodiments include an apparatus for transmitting the data flow to the user device after requested data from the data storage device has been transmitted by the interface or at any other time (e.g. before or at the same time as the data flow data). For example, the requested data flow data may be transmitted from the storage device to the requesting device by unicast transmission, which then may or may not forward this data on to the client that requested it.

Various exemplary embodiments include a controller for controlling the service request device, the controller causing the device to service the request if the module determines that the device can do so.

Various exemplary embodiments include a monitor for monitoring information about the data stored in the data storage device and for providing the information to the module. In various exemplary embodiments, the data storage device stores VoD data from a plurality of Video On Demand titles, and the information identifies the titles for which data is stored in the storage device.

In various exemplary embodiments, the apparatus is located in a network element, for example an access node or another node.

Various exemplary embodiments include a network element with an ingress interface for receiving data from a plurality of video servers, an egress interface having a plurality of ports, each for supplying data from a selected video title received at the ingress interface to a device connected to a respective port.

Various exemplary embodiments include an interface for receiving requests for VoD data, a selector operatively coupled to the interface for selecting from a plurality of VoD data request service devices, a device for servicing a particular request irrespective of the VoD data request service device identified for servicing the request in the received request.

Various exemplary embodiments achieve the benefit of leveraging availability of relatively inexpensive mass storage and leveraging popularity of certain VoD content. For example, various exemplary embodiments leverage the availability of new video title releases.

Various exemplary embodiments enable the storing of local copies of popular VoD content. In various exemplary embodiments, this reduces the bandwidth demands on the network. In turn, in various exemplary embodiments, costs are offset with respect to local VoD cache. In various exemplary embodiments, one or more of the foregoing advantages or benefits are obtained through savings in the required network capacity to support a video on demand service.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the invention resides in the novel methods, arrangements, combinations and improvements herein shown and described according to various exemplary embodiments.

In light of the present need for an apparatus, system and/or method capable of achieving one or more of the foregoing objects, a brief summary of various exemplary embodiments is presented. Some simplifications and omission may be made in the following summary, which is intended to highlight and introduce some aspects of the various exemplary embodiments, but not to limit its scope.

### BRIEF DESCRIPTION OF THE DRAWINGS

In order to better understand various exemplary embodiments, reference is made to the accompanying drawings, wherein:

FIG. 1 is a schematic diagram of a first exemplary communication network for transmitting VoD media data;

FIG. 2 is a schematic diagram of a first exemplary embodiment of a VoD apparatus;

FIG. 3 is a schematic diagram of a second exemplary embodiment of a VoD apparatus;

FIG. 4A is a flow diagram of a first exemplary embodiment of a process of determining if a particular VoD data request service device can handle a VoD data request;

FIG. 4B is a flow diagram of a second exemplary embodiment of a process of determining if a particular VoD data request service device can handle a VoD data request;

FIG. 5 is a schematic diagram of a first exemplary embodiment of an access node;

FIG. 6 is a schematic diagram of a second exemplary embodiment of an access node;

FIG. 7 is a schematic diagram of a third exemplary embodiment of an access node;

FIG. 8 is a schematic diagram of a second exemplary communication network for transmitting VoD media data;

FIG. 9 is a schematic diagram of a third exemplary communication network for transmitting VoD media data; and

FIG. 10 is a schematic diagram of a fourth exemplary communication network for transmitting VoD media data.

### DETAILED DESCRIPTION

Referring now to the drawings, in which like numerals refer to like components or steps, there are disclosed broad aspects of various exemplary embodiments.

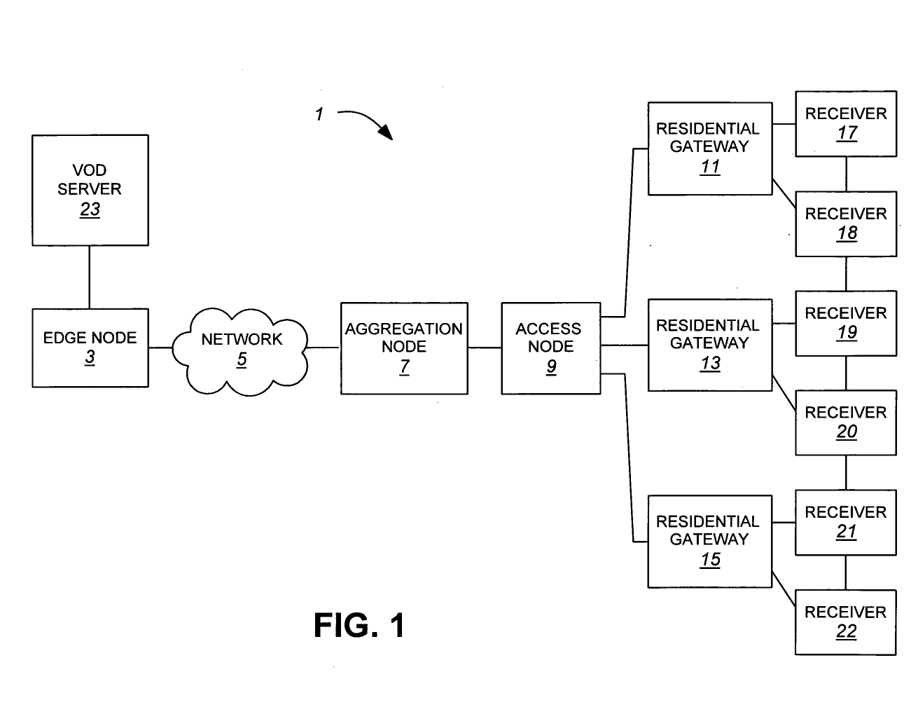

FIG. 1 is a schematic diagram of a first exemplary communication network 1 for transmitting VoD media data. This is an example of a typical network for providing IP services to a number of subscribers. The exemplary communication network 1 includes edge nodes 3 (only one shown) for providing IP media services from one or more video on demand data sources or video on demand servers 23 (only one shown), a network 5 connected to the edge node 3, an aggregation node 7, and an access node 9 connected to the aggregation node 7 and for delivering IP services to a number of different subscriber premises. Thus the VoD data is received by receivers 17, 18, 19, 20, 21, 22 from access node 9 via residential gateways 11, 13, 15.

This is an example of an end to end network. There are additional layers of physical devices in various exemplary embodiments. FIG. 1 shows basic functional blocks of various exemplary embodiments.

In various exemplary embodiments, the customer premises equipment (CPE) includes a residential gateway device 11, 13, 15 and one or more receiver(s) 17, 18, 19, 20, 21, 22 which may for example comprise a set top box for a television set, computer or other end user equipment. In various exemplary embodiments, the access node 9 includes, for example, a DSLAM (digital subscriber line access multiplexer) which is connected to subscriber equipment by wire lines and provides xDSL access, some form of fiber to the Node system where the subscriber is connected to the network 5 via optical fiber, or other access technology such as a wireless system (e.g. transceiver).

In various exemplary embodiments, IP media services, such as Video On Demand services are unicast via the edge node 3 over the network 5 to the access node 9, via the aggregation node 7. In various exemplary embodiments, the access node 9 delivers the VoD content in unicast to the receiver(s) 17, 18, 19, 20, 21, 22 at one or more subscriber premises.

In various exemplary embodiments providing a video on demand title, when a subscriber requests the VoD title, the request is unicast from the residential gateway 11, 13, 15 through the network 5 to the edge node 3, and then to a VoD server 23 that transmits the required video stream via a unicast signal back to the requesting subscriber. In various exemplary embodiments, an analogous process is performed when the customer premises equipment requests a lost video data packet.

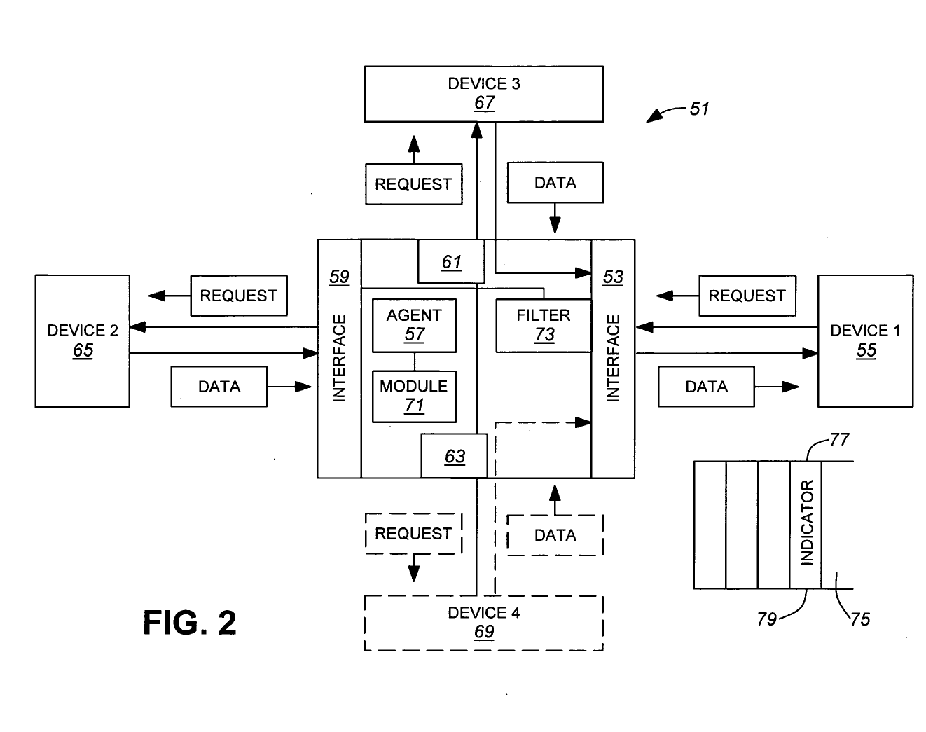

FIG. 2 is a schematic diagram of a first exemplary embodiment of a VoD apparatus 51. Exemplary VoD apparatus 51 includes a first interface 53 for receiving VoD data from a first device 55, and an agent 57 for receiving VoD data from the interface 53. In the embodiment depicted, the exemplary apparatus 51 further includes second, third and fourth interfaces 59, 61, 63 for communication with second, third and fourth devices 65, 67, 69, respectively.

In various exemplary embodiments, agent 57 runs in a DSLAM for directly and transparently accessing a local VoD caching device (not shown) where VoD content is stored. In various exemplary embodiments, agent 57 maintains communication with a local VoD caching device (not shown). In various exemplary embodiments, the local VoD caching device contains information on currently available content. In various exemplary embodiments, the agent 57 monitors the system for requests for VoD content by client devices. In various exemplary embodiments, the agent 57 relays requests for VoD content to the local VoD caching device based on the availability of the requested content on that device.

In various exemplary embodiments, when requested VoD content is not available on a local VoD caching device, agent 57 redirects the request into the network 5 to be handled in a customary manner.

In various exemplary embodiments, as VoD data arrives at access node 9 from network 5, the VoD data is automatically directed to the local VoD caching device for caching. In various exemplary embodiments, this is beneficial because the requested VoD content is not already present on the local VoD caching device.

In various exemplary embodiments, when cached VoD content reaches a predetermined expiry, it is removed from the local VoD caching device. In various exemplary embodiments, when the local VoD caching device fails, or is at a limit of its storage capacity, the agent 57 allows requests for VoD content to pass through the access node 9 unaltered to be fulfilled in the customary manner. The foregoing description of functions and benefits related to agent 57 would be described in greater detail below.

In various exemplary embodiments, agent 57 is configured for directing VoD requests received from one device and which is addressed for processing by and to a particular device to another device for processing. In various exemplary embodiments, agent 57 is adapted for receiving VoD requests from the first device 55 which is addressed for processing by the second device 65 and directs the VoD request to another device other than the second device 65 for processing the data, for example, the third or fourth device 67, 69. In various exemplary embodiments, the agent 57 is configured to receive VoD requests destined for any of the second, third or fourth devices 65, 67, 69 addressed for processing by a particular device, and to direct the VoD requests to another device to process the VoD data.

In various exemplary embodiments, the agent 57 is configured to transmit VoD data only to one alternative device for processing the VoD data. In various exemplary embodiments, the agent 57 is configured to direct VoD data both to the device to which the VoD data is addressed and also to one or more other devices for processing. In various exemplary embodiments, the agent 57 is configured to redirect the VoD requests to a plurality of other devices, and not pass the VoD requests to the device to which they are addressed.

In various exemplary embodiments, the exemplary apparatus 51 includes a module 71 for determining which device or devices the agent 57 is to direct the VoD request. In various exemplary embodiments, the module 71 is adapted to make such a determination based on one or more predetermined criteria.

In various exemplary embodiments, the VoD data which the agent 57 is configured to direct to another device are VoD requests to receive VoD data. Various exemplary embodiments include a module 71 for determining a device to which to transmit data, wherein the module 71 determines the device to which the VoD data is to be sent based on a device's ability to service the VoD data or request for VoD data.

Various exemplary embodiments of the apparatus 51 are implemented in a communication system. Accordingly, in various exemplary embodiments, the first device 55 includes a receiver 17, 18, 19, 20, 21, 22 for receiving media data such as VoD data. In various exemplary embodiments, the first device 55 is located at a subscriber premises. In various exemplary embodiments, the apparatus 51 is located at a network element (or node), such as access node 9 (or other node) for transmitting VoD data to subscriber equipment, including the first device 55.

In various exemplary embodiments, the second device 65 includes a server connected to the second interface 59 for providing VoD data to subscriber equipment. In various exemplary embodiments, the second device 65 is located at, or connected to, a node of a communication network such as access node 9 of network 5. In various exemplary embodiments, a server of the second device 65 provides portions of video data to enable subscriber equipment to rapidly receive a video stream, and/or provides lost data packets such as video data packets.

In various exemplary embodiments, the third device 67 and/or the fourth device 69 include a data request service device for servicing requests for data from subscriber equipment, for example, requests for video streams and/or lost data packets. In various exemplary embodiments, either one or both of the third and fourth devices 67, 69 are co-located within the exemplary apparatus 51 as depicted. In other exemplary embodiments either one or both of the third and fourth devices 67, 69 are located more remotely and connected to the apparatus 51 by a suitable communication link or network. In various exemplary embodiments, the third and/or fourth devices 67, 69 are located closer to the first device 55 than to the second device 65.

In an exemplary embodiment of a method of providing VoD data, a subscriber initiates a request for a video on demand title, the subscriber equipment 55 transmits a request for the video on demand title for servicing by the second device 65. The agent 57 intercepts the request and directs the request to one or more devices. In various exemplary embodiments, the particular device or devices to which the request is directed by the agent 57 depends on a determination made by the module 71. In other exemplary embodiments, if the module 71 is present, the particular device or devices to which the request is directed by the agent 57 does not depend on a determination made by the module 71.

In various exemplary embodiments, the agent 57 is configured to direct VoD data requests addressed to the second device 65 to the third device 67 and/or the fourth device 69 without considering any other factor. The device to which the request is redirected, e.g. the third or fourth device 67, 69, services the request and transmits the requested VoD data to the subscriber device 55 via the interface 53 (or another interface).

In various exemplary embodiments, the agent 57 is configured to direct requests for VoD data to a device based on a determination made by the module 71. In various exemplary embodiments, the module 71 determines whether a particular alternative device to that to which the request is addressed has the requested data or is otherwise able to service the request. In various exemplary embodiments, the module 71 determines whether the alternative device has the capacity to service the request.

In various exemplary embodiments where the module determines that each alternative device is unable to service the request, the module 71 controls the agent 57 to direct the request to the device to which the request is originally addressed, for example the second device 65. In various exemplary embodiments where the module 71 determines that an alternative device, e.g. the third or fourth device 67, 69, is able to handle the request, the module 71 controls the agent 57 to direct the request to that alternative device. In various exemplary embodiments where the agent 57 directs a request for data to an alternative device, the agent 57 is adapted either not to transmit the request also to the device to which the request is addressed or to also transmit the request to the device to which the request is addressed either as is or modified to have itself as the originator of the request.

In various exemplary embodiments, the agent 57 is configured to intercept VoD requests and is capable of operating independently of (or transparently to) the device to which the request is addressed. In various exemplary embodiments, the need is eliminated for the agent 57 and/or the device servicing the data or request for data to be identified or identifiable to the addressed device or to the system, for example to the middleware platform that delivers the requested data, e.g. IPTV video data or lost packets.

Various exemplary embodiments include a filter 73 or selector. In various exemplary embodiments, the filter 73 is adapted to identify from VoD requests received from the first device 55 that requests which are to be handled by the agent 57 and to pass those VoD requests to the agent 57, and to cause other requests which is not intended for the agent 57 to bypass the agent 57. In various exemplary embodiments, a filtering function performed by the filter 73 assists in increasing the speed and efficiency with which the exemplary apparatus 51 handles requests including VoD requests.

In various exemplary embodiments, VoD requests intended to be handled by the agent 57 include a characteristic which assists in identifying the VoD requests as data to be handled by the agent 57. In various exemplary embodiments, a data packet 75 transmitted from the first device 55 includes a field 77 for carrying an indicator 79 which indicates that the data packet 75 is to be handled by the agent 57.

In various exemplary embodiments, filter 73 specifically looks for packets which include the indicator 79 and discriminates between packets which are to be forwarded to the agent 57 and packets that are not to be forwarded to the agent 57 based on the presence and absence of indicator 79. Thus, in various exemplary embodiments, filter 73 provides a means of enabling the apparatus 51 to more rapidly identify data which is to be handled by the agent 57.

Although in the exemplary embodiment depicted in FIG. 2, the filter 73 is shown as a separate component, in various exemplary embodiments, the agent 57 performs a filtering function as described above in connection with the filter 73. In various exemplary embodiments, interface 53 performs a filtering function as described above in connection with the filter 73. Similarly, in various exemplary embodiments, the filtering function is performed by a device other than filter 73, agent 57, or interface 53.

In various exemplary embodiments, the agent 57 is implemented by any suitable means, in hardware, software, or a combination of both. For example, in various exemplary embodiments, the agent 57 includes a processor and computer program running thereon, another programmable or configurable device, an FPGA (Field Programmable Gate Array), a programmable logic device (PLD), a programmable logic array (PLA), or other logic or digital circuit.

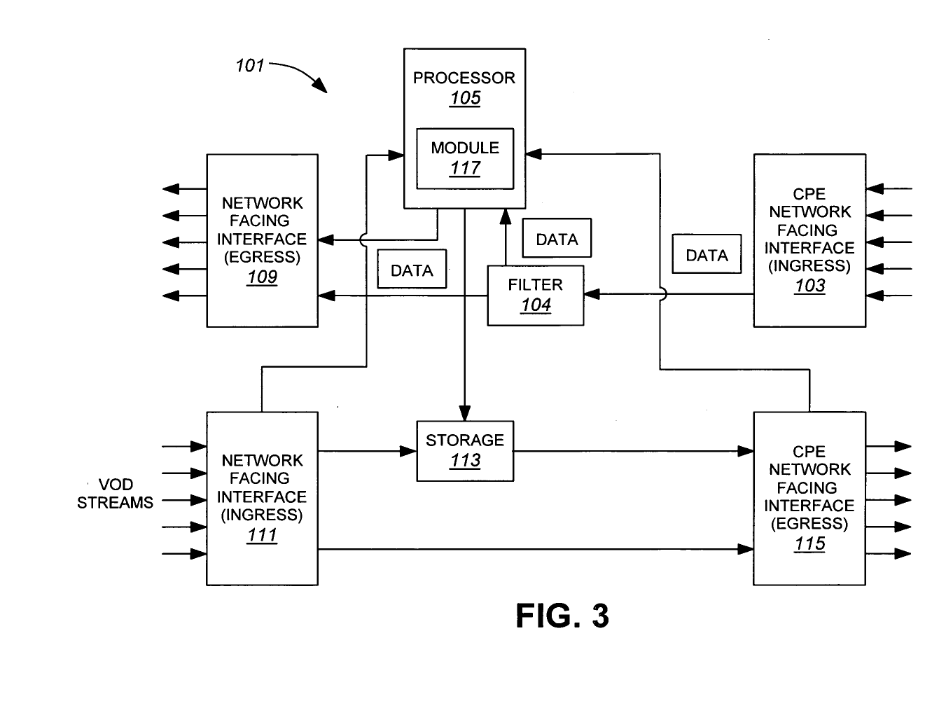

FIG. 3 is a schematic diagram of a second exemplary embodiment of a VoD apparatus 101. Exemplary apparatus 101 includes a first interface 103 for receiving requests for VoD data from a device connected thereto (not shown), an optional filter 104, a processor 105 for processing the received requests for VoD data, a memory for storing data used by the processor 105, and a second interface 109 for outputting VoD data to another device (not shown). In various exemplary embodiments, the filter 104 is configured to discriminate between data that is to be passed to the processor 105, and to forward that data to the processor 105, and otherwise pass the data to another device, such as the second interface 109.

Various exemplary embodiments include a third interface 111 for receiving unicast media data from a network, and storage 113 for storing media data from the third interface 111, and a fourth interface 115 for outputting media data to subscriber equipment. In various exemplary embodiments, storage 113 is designed to store media data received by the third interface 111 for servicing data requests from subscriber equipment. In various exemplary embodiments, requested data is a request for a specific VoD title or a request for one or more lost VoD data packets.

Various exemplary embodiments include a module 117. In various exemplary embodiments, the module 117 is implemented by the processor 105 which performs either one or both of the following two functions: (1) determining if a received request can be serviced by a predetermined request service device, which in various exemplary embodiments is the request service device provided by the storage device 113, and forwarding the request to another device via the second interface 109 if the processor 105 determines that the predetermined request service device is unable to service the request; and (2) intercepting and processing requests for VoD data that are addressed to another data request service device.

In various exemplary embodiments, storage device 113 is controlled to store media data from a predetermined number of video titles which is likely to be fewer than the number of video titles available to subscribers. In various exemplary embodiments the particular titles stored in the storage device 113 is predetermined and does not vary over time. In various exemplary embodiments the particular titles stored in the storage device 113 varies over time in a predetermined manner. In various exemplary embodiments the particular titles stored in the storage device 113 varies over time dynamically in response to subscriber demand.

In various exemplary embodiments storage device 113 is controlled only to store media data from those titles which have recently been requested. In various exemplary embodiments storage device 113 only commences storing a title when that title has been requested by one or more subscribers, or via other network driven criteria. In various exemplary embodiments, processor 105 monitors the state and residual capacity of the storage device 113 and manages which titles the storage device 113 continues to store and which titles to remove from a buffer when the number of titles requested exceeds a capacity of the storage device 113.

In various exemplary embodiments, the information on the titles stored in the storage device 113 is used by the module 117 to determine whether the storage device 113 can service a particular request for data, and to determine whether to forward the request for data to another request service device. In various exemplary embodiments, the titles list is updated regularly, for example, continually or on a periodic basis.

In various exemplary embodiments, one or more other parameters or conditions are monitored and also used by the module 117 in determining whether the request for data can be serviced by the local request service device or should be forwarded to another device. Examples of parameters or conditions that are monitored in various exemplary embodiments include the available bandwidth of the egress interface 115 and/or the available bandwidth or capacity of any one or more of the other interfaces 103, 109, 111, the number of requests for data received within a predetermined timeframe (e.g. the request pipeline), the status of the local data request servicing device, for example whether the device is operating correctly or whether a malfunction, fault or failure has been detected, the available processing power to service the request(s) and/or the status of another data request service device. In various exemplary embodiments where a determination is made that another data request service device (e.g. the device to which the request is addressed) is incapable of handling the request for whatever reason, the module 117 determines that the request is to be handled by the local device.

In various exemplary embodiments, only titles that are currently being requested by subscribers are supplied to the network ingress interface 111. This potentially minimizes the communication network bandwidth used for delivering media data to subscribers. However, in various exemplary embodiments, the number of titles supplied to the ingress interface 111 exceeds those actually currently requested by subscribers and comprises some or all titles that are potentially available to subscribers.

As described above, in various exemplary embodiments, the requests for data received from one or more subscriber(s) are addressed to a request service device other than the local request service device, for example, a device which is located closer to or at the media data source. Various exemplary embodiments intercept requests that are addressed for servicing by another device, and if the module 117 determines that the request can be serviced by the local device, module 117 directs the local device to service the request. However, in various exemplary embodiments, requests for data are specifically addressed to the apparatus 101, and the apparatus 101 determines which device (e.g. local or remote) is to service the request.

Thus, in various exemplary embodiments, the local device acts as an agent for the intended request service device and is transparent to the subscriber equipment as there is no requirement to specifically address the agent in the request for data or to modify the subscriber equipment to do so. In various exemplary embodiments, where the module 117 determines that the request can be serviced by the local device, the apparatus 101 determines not to forward the request to the intended recipient, in which case operation of the agent is also transparent to the data request service device to which the request for data is addressed.

In various exemplary embodiments, the apparatus 101 is configured to forward a request for data to the intended request service device even though the module 117 determines that the request can be serviced by the local device. Thus, in various exemplary embodiments, the apparatus 101 automatically forwards a request to the intended recipient in the interest of expediency and subsequently determines that the local device can service the request. In various exemplary embodiments, the apparatus 101 sends a message or signal to the intended request service device to nullify or cancel the request for data to prevent the request being serviced by the remote device.

In various exemplary embodiments, automatically intercepting requests for data destined for another device removes the need for special equipment to coordinate operation between one request service device and another, such as special interfaces for transmitting and receiving control signals, and removes the need for addressing such interfaces and the delay which might result in servicing data requests caused by the need to coordinate operation between the two devices in this manner.

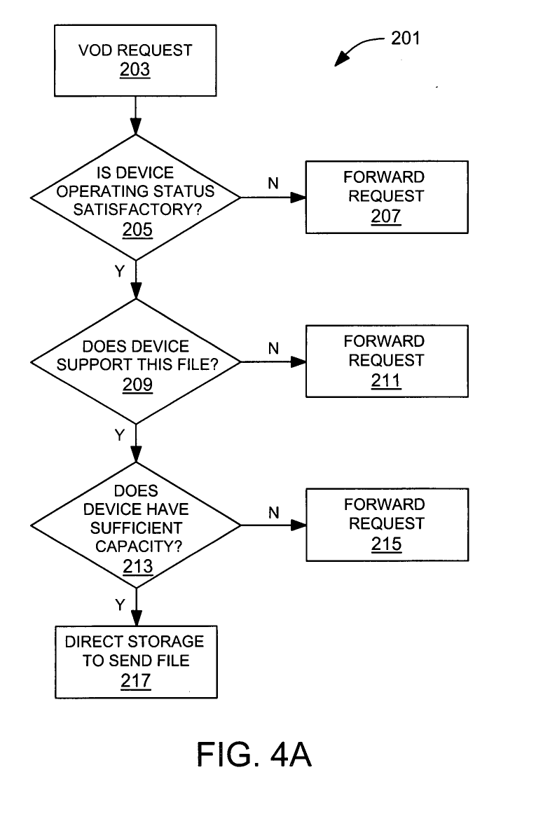

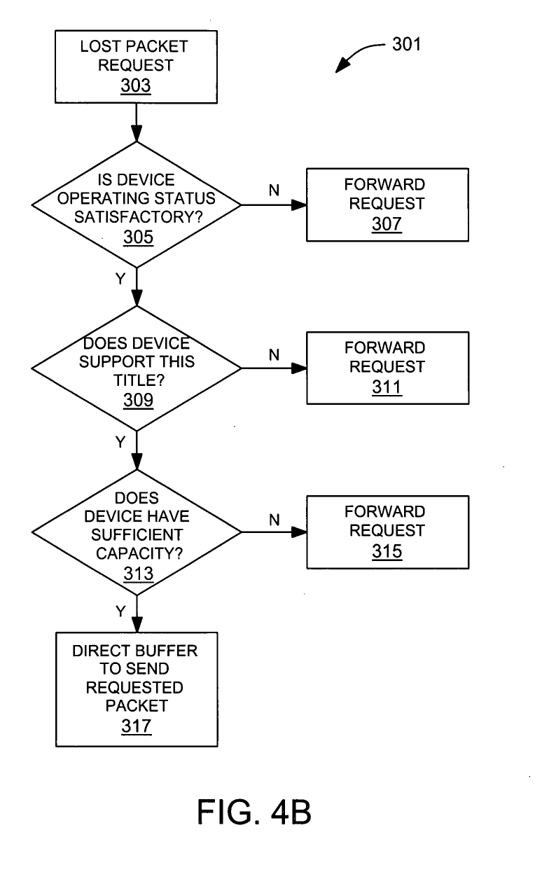

FIG. 4A is a flow diagram of a first exemplary embodiment of a process 201 of determining if a particular VoD data request service device can handle a request for VoD data. This is an exemplary embodiment of the operation when a subscriber requests a video on demand title.

At exemplary step 203, a video on demand title request is received by the apparatus via the interface 103 from a subscriber. In various exemplary embodiments, the VoD title request is addressed to a remote service request device or directly to the local device. At exemplary step 205, the module 117 determines whether the operating status of the local device is satisfactory to be able to service the request.

In various exemplary embodiments, where a determination is made that the operating status is not satisfactory, for example due to a malfunction or failure of the local device, the apparatus determines that the request should be forwarded to another request service device in step 207. If it is determined that the local device operating status is satisfactory, the process proceeds to the next inquiry at step 209.

At exemplary step 209, the module 117 determines whether the local device supports the requested title, i.e. whether media data from the requested title is currently being stored in the storage device 113. If the title is not contained in the list (and therefore not stored in the storage device 113), the title request is forwarded towards or to another device, e.g. the device to which the request is addressed, or to a secondary pre-configured network device via the second interface 109. This occurs in exemplary step 211. If the module 117 determines that the local device does support the title, the process proceeds to the next inquiry at step 213.

At exemplary step 213, the module 117 determines whether the local device has sufficient capacity to handle the request. In various exemplary embodiments, the module 117 checks whether the egress interface 115 has sufficient bandwidth to accommodate a unicast transmission containing the requested media data to the requesting subscriber equipment. In various exemplary embodiments, this is achieved by monitoring the available bandwidth and comparing this with the required bandwidth for servicing the request.

In various exemplary embodiments, where the module 117 determines that the local device does not have sufficient capacity, the apparatus forwards the request to another device via the interface 109 in exemplary step 215. In various exemplary embodiments, where the module 117 determines that the local device does has sufficient capacity, in exemplary step 217, the module 117 directs the local service device to send the requested data, for example, video data, to the subscriber equipment.

FIG. 4B is a flow diagram of a second exemplary embodiment of a process 301 of determining if a particular VoD data request service device can handle a request for missing packets. In the exemplary embodiment shown, the process is performed by the module 117 for determining whether the local device can service a request for one or more lost VoD data packets. The exemplary process depicted in FIG. 4B is similar to that described above for title requests illustrated in FIG. 4A and similar steps are represented by the same reference numerals incremented by 100. Thus, exemplary steps 303, 305, 307, 309, 311, 313, 315 and 317 correspond, respectively, to exemplary steps 203, 205, 207, 209, 211, 213, 215 and 217. In this manner, the description of the process shown in FIG. 4A applies equally to that shown in FIG. 4B.

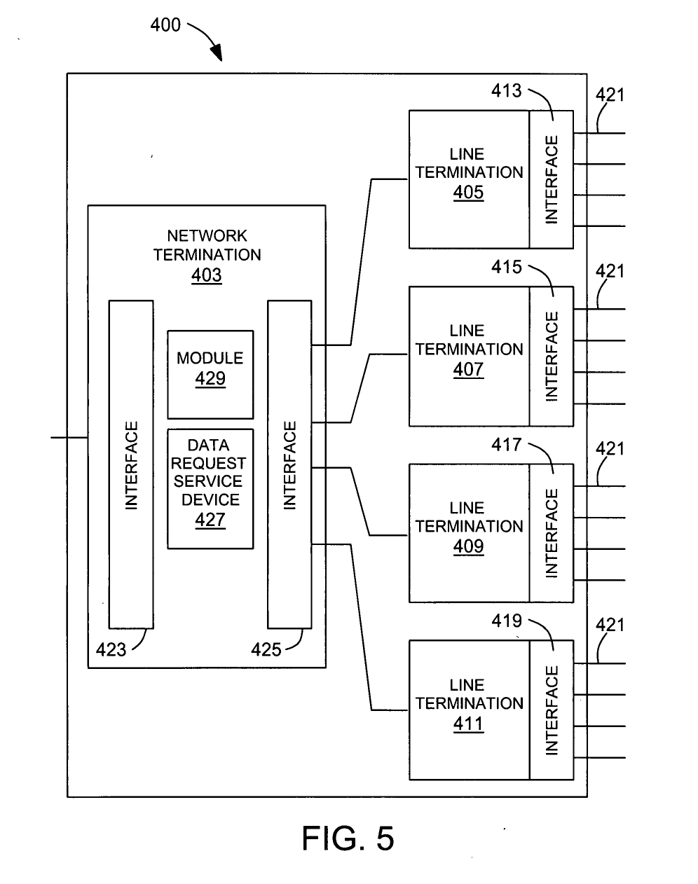

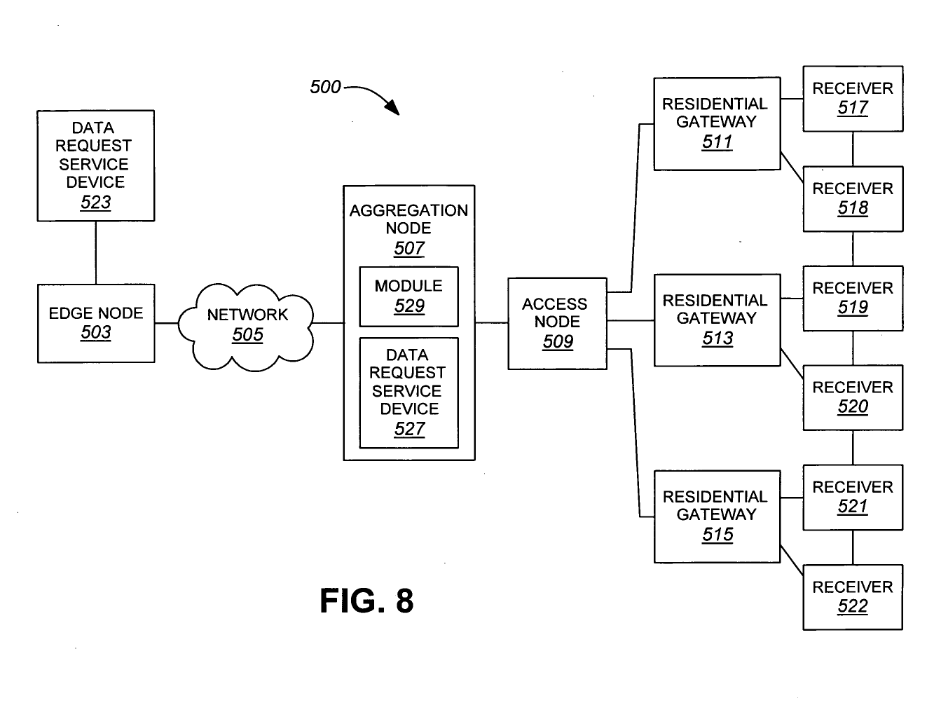

FIGS. 5, 6 and 7 show various exemplary embodiments of an access node, and FIGS. 8, 9 and 10 show various exemplary embodiments of communication networks.

FIG. 5 is a schematic diagram of a first exemplary embodiment of an access node 400. Exemplary access node 400 includes a network termination device 403 and a plurality of line termination devices 405, 407, 409, 411 each having an interface 413, 415, 417, 419 having one or more ports 421 for connection to customer premises equipment. In various exemplary embodiments, the network termination device 403 has a first interface 423 for transmitting and receiving data and requests for data to and from a communication network, and a second interface 425 to enable communication between the network termination device and each line termination device 405, 407, 409, 411.

In various exemplary embodiments, the network termination device 403 includes a data request service device 427 for servicing data requests received from the interface 425, and a module 429 for intercepting data requests received from the interface 425 and determining whether or not the request is to be serviced by the local device 427 or forwarded to another device, for example a device to which the request is actually addressed. In various exemplary embodiments, the module 429 and/or data request service device 427 are implemented and operate according to any of the various exemplary embodiments of like devices described above and below in connection with other Figures.

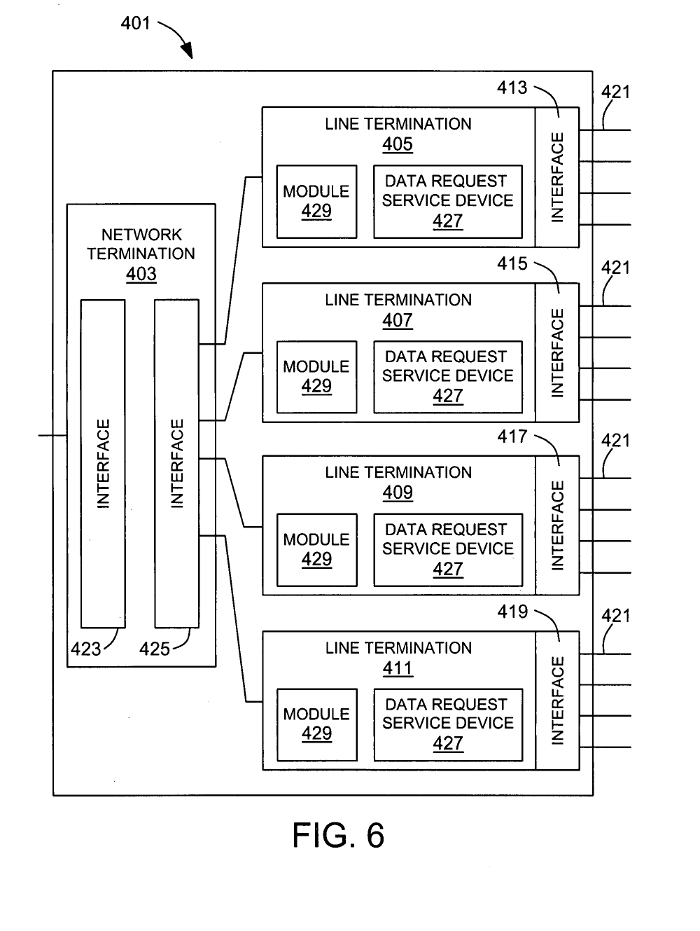

FIG. 6 is a schematic diagram of a second exemplary embodiment of an access node 401. Exemplary access node 401 includes a network termination device 403 and a plurality of line termination devices 405, 407, 409, 411 each having an interface 413, 415, 417, 419, respectively, and is similar to the exemplary embodiment depicted in FIG. 5. Like parts are designated by the same reference numerals. However, in the exemplary embodiment depicted in FIG. 6, each line termination device 405, 407, 409, 411 includes a data request service device 427 for servicing data requests from subscriber equipment, and a module 429 for determining whether a respective service device 427 is to service a particular request or whether the request is to be forwarded to another device. In various exemplary embodiments, one or more service request devices 427 and one or more modules 429 operate according to any of the various exemplary embodiments of like devices described above and below in connection with other Figures.

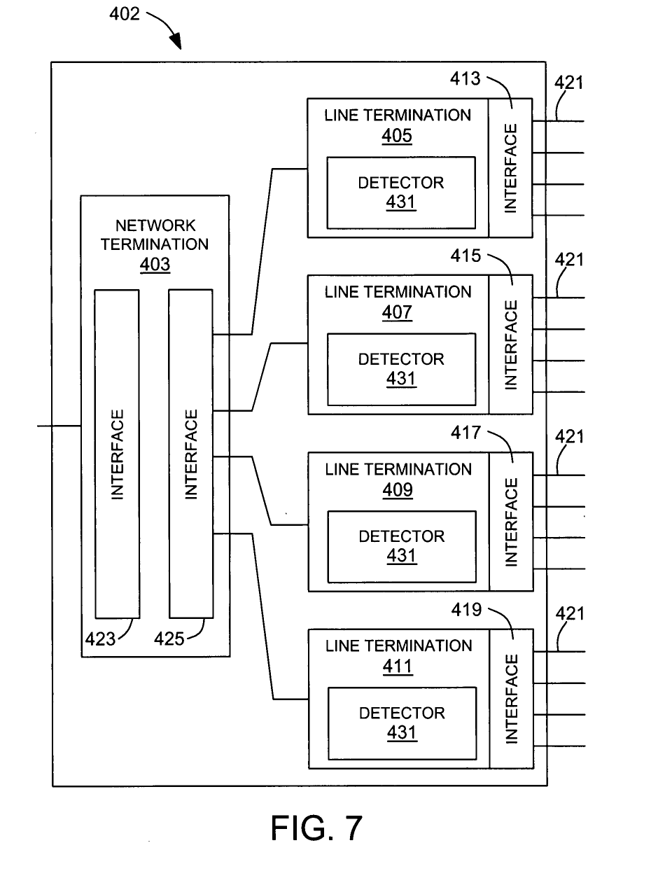

FIG. 7 is a schematic diagram of a third exemplary embodiment of an access node 402. Exemplary access node 402 is similar to exemplary access nodes 400, 401, described above in connection with FIG. 5 and FIG. 6. Exemplary access node 402 includes a network termination device 403 and a plurality of line termination devices 405, 407, 409, 411, each having an interface 413, 415, 417, 419, respectively, and is similar to the exemplary embodiments of FIGS. 5 and 6. Like parts are designated by the same reference numerals.

In various exemplary embodiments, the network termination device 403 includes a data request service device 427 and a module 429, and each line termination device 405, 407, 409, 411 includes a detector 431. In various exemplary embodiments, detector 431 detects from signals received from subscriber equipment, requests for data, for example, video title data or lost VoD data packets and for passing the detected requests to the module 429 for further processing.

In various exemplary embodiments, the detector 431 is dedicated to detecting requests for data. In various exemplary embodiments, this increases the speed at which the apparatus can make a determination as to whether the request is to be handled by the local request service device 427 or forwarded to another device for processing.

In various exemplary embodiments, detector 431 is adapted to perform request detection by looking for one or more specific attributes, artifacts or characteristics which uniquely identify a data request from other types of packets, data or signals received from subscriber equipment. In various exemplary embodiments, detector 431 is adapted to look at a specific portion of a data packet, for example an address, part of an address or another parameter in the packet, or a specific tag or label in the packet which is inserted or added into the packet by subscriber equipment or intermediate device such as the residential gateway.

In should also be apparent, by combining various features shown in FIGS. 5, 6 and 7, that in various exemplary embodiments, each line termination device 405, 407, 409, 411 includes a module 429 and the data request service device 427 is situated at the network termination device 403.

Although FIGS. 5 to 7 show exemplary embodiments of the apparatus incorporated into an access node, in various exemplary embodiments, the apparatus is incorporated into any other network element of a communication network, or as a stand alone network device.

FIG. 8 is a schematic diagram of a second exemplary communication network 500 for transmitting VoD media data. Exemplary communication network 500 includes a data request service device 527 for servicing data requests and a module 529 for intercepting data requests destined for another request service device and for determining whether the local request service device can service the request that are co-located with an aggregation node 507 upstream of the access node 509.

In various exemplary embodiments, a plurality of apparatuses according to various exemplary embodiments are incorporated into a plurality of network elements.

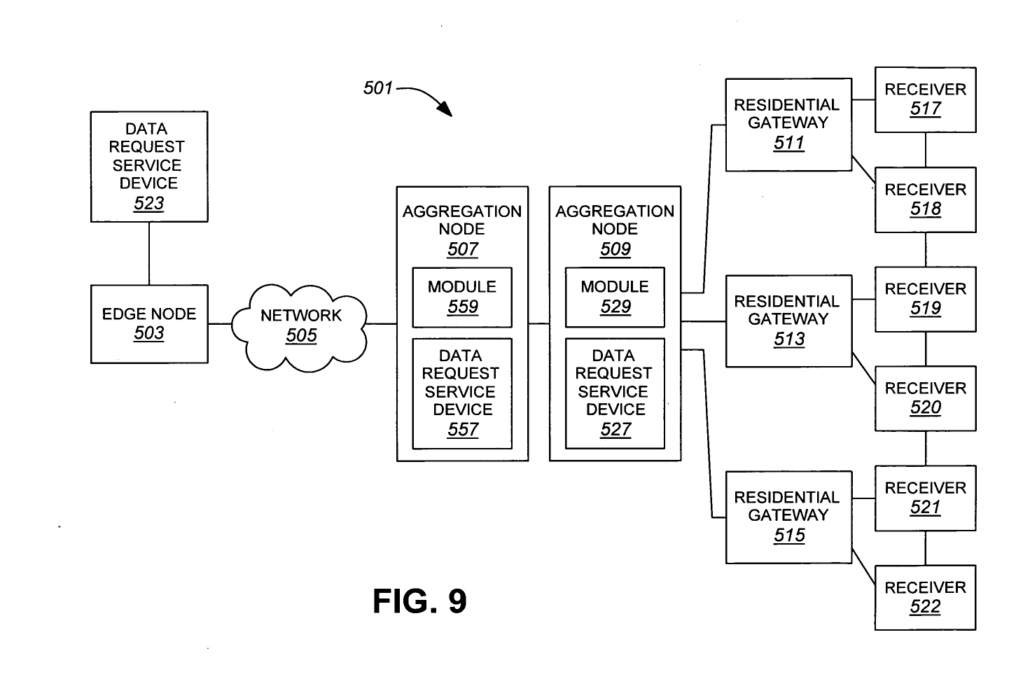

FIG. 9 is a schematic diagram of a third exemplary communication network 501 for transmitting VoD media data. Exemplary communication network 501 includes a data request service device 527 and a module 529 for determining whether a request can be serviced by the local request service device in access node 509 and a data request service device 557 and a module 559 for determining whether a request can be serviced by the local request service device an aggregation node 507.

In various exemplary embodiments, data request service devices 527, 557 and modules 529, 559 operate in a similar manner to that described above or below with respect to like elements. In various exemplary embodiments, data request service devices 527, 557 and modules 529, 559 operate as hierarchical pairs.

In various exemplary embodiments, where data request service device 527 and module 529 at the access node 509 determine that a particular request cannot be serviced by its local service request device, the request is forwarded from the access node 509 to data request service device 557 and module 559 situated at the aggregation node 507. In various exemplary embodiments, data request service devices 527, 557 and modules 529, 559 are adapted to intercept the data request (even though it may be addressed to another device such as a request service device near edge node 503), and make a similar determination as to whether its local request service device can handle the request. Thus, various exemplary embodiments include a reciprocal redundancy between pairs of data request service devices 527, 557 and modules 529, 559, and each operates as an agent for the destination request service device to which the request is addressed.

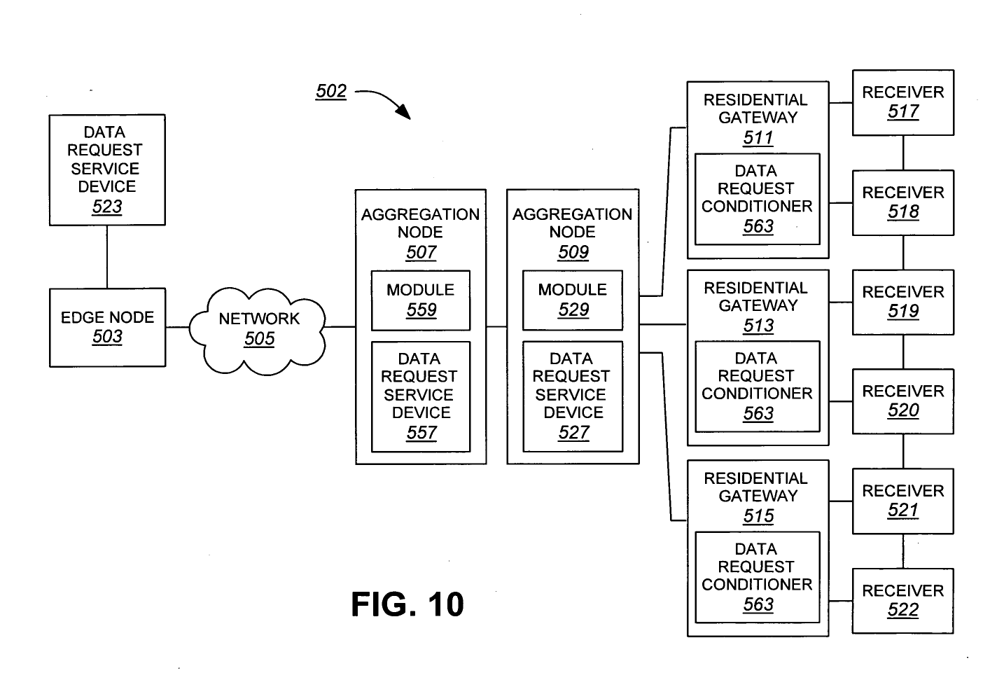

FIG. 10 is a schematic diagram of a fourth exemplary communication network 502 for transmitting VoD media data. Exemplary network 502 is similar in many respects to exemplary network 501 shown in FIG. 9, and like parts are designated by the same reference numerals. With exemplary network 502, each residential gateway 511, 513, 515 includes a data request conditioner 563 for conditioning each data request to facilitate its detection and interception according to various exemplary embodiments described herein. In various exemplary embodiments, the conditioner 563 inserts or adds a unique tag, label, artifact or other device to each data request which is recognizable by the apparatus to enable the apparatus to discriminate between data requests and other data or signals transmitted from subscriber equipment to the access node 509.

Network 505, data request service device 523, and receivers 517, 518, 519, 520, 521, 522 correspond to network 5, data request service device 23, and receivers 17, 18, 19, 20, 21, 22 in FIG. 1, respectively.

In the exemplary embodiment of FIG. 3, the module 117 is implemented in processor 105. In various exemplary embodiments, the module 117 is implemented by any other means in either hardware or software or a combination of both, is implemented in a dedicated device, such as an FPGA (field programmable gate array) or ASIC (application specific integrated circuit), programmable logic device (PLD) or programmable logic array (PLA), or by any other means, including a combination of a processor and aforementioned devices.

In various exemplary embodiments, any one or more features described above in connection with the specific embodiment depicted in any one Figure are combined with any one or more features described above in connection with the specific embodiment depicted in any one other Figure, or with any one or more features of any plurality of the other various exemplary embodiments disclosed herein. Thus, although the various exemplary embodiments have been described in detail with particular reference to certain exemplary aspects thereof, it should be understood that the invention is capable of other different embodiments and various combinations of aspects of the various exemplary embodiments described, and its details are capable of modifications in various obvious respects. As is readily apparent to those skilled in the art, variations and modifications can be affected while remaining within the spirit and scope of the invention. Accordingly, the foregoing disclosure, description, and Figures are for illustrative purposes only, and do not in any way limit the invention, which is defined only by the claims.

What is claimed is:

1. An apparatus comprising an interface for receiving video on demand data requests addressed for processing by and to a predetermined entity, and an agent operatively coupled to the interface and being configured for re-directing said video on demand data requests to an entity other than said predetermined entity for processing said data.

2. An apparatus as claimed in claim 1, wherein said agent is adapted to determine an operation to be performed on said video on demand data by said predetermined entity and to select said other entity based on its ability to perform said determined operation.

3. An apparatus as claimed in claim 1, wherein said video on demand data comprises a request for video on demand data from said predetermined entity.

4. An apparatus as claimed in claim 1, further comprising a module for determining whether to direct said video on demand data requests to said predetermined entity or to said other entity based on one or more predetermined criteria.

5. An apparatus as claimed in claim 4, wherein said predetermined criteria is selected from the list consisting of the status of said predetermined entity, the status of said other entity, and where the video on demand data comprises a request for video on demand data, whether the other entity has the requested video on demand data.

6. An apparatus as claimed in claim 1, wherein said address comprises a communication network address.

7. An apparatus comprising:
a first interface for receiving requests for video on demand data from a device;
a module for determining if a received request can be serviced by a predetermined request service device; and
a second interface for outputting the received request to another request service device if the module determines that the predetermined request service device cannot service the request.

8. An apparatus as claimed in claim 7, further comprising a selector for selecting for said determination by said module, requests for video on demand data addressed for servicing by a device other than said predetermined request service device.

9. An apparatus as claimed in claim 7, further comprising a selector for identifying and selecting requests for video on demand data for said determination by said module from other signals received by said first interface.

10. An apparatus as claimed in claim 7, wherein said module is adapted to determine if a received request can be serviced by said predetermined request servicing device according to one or more predetermined criteria.

11. An apparatus as claimed in claim 10, wherein said predetermined criteria is selected from the list consisting of:
that the request cannot be serviced if the requested video on demand data is not available at said predetermined request service device;
that even if said video on demand data is available at said predetermined request service device, the device cannot service the request based on the status of the device; and
that the request cannot be serviced based on a predetermined status of the device.

12. An apparatus as claimed in claim 7, wherein the request for video on demand data is selected from the list consisting of a request for video data, and a request for a portion of video on demand data of a video on demand data stream carried on a predetermined title.

13. An apparatus as claimed in claim 12, wherein the portion of video on demand data is selected from the list consisting of a portion of video on demand data to enable a device to operate, one or more identified video on demand data packets, and video on demand data to enable a device to display an image defined by said video on demand data.

14. An apparatus as claimed in claim 7, wherein said predetermined request service device comprises a video on demand data storage device for storing video on demand data for servicing requests for video on demand data.

15. An apparatus as claimed in claim 14, wherein said video on demand data storage device is operatively coupled to one or more sources for supplying one or more video on demand data flows, and said video on demand data storage device is adapted to temporarily store and then discard successive portions of each video on demand data flow for servicing requests for video on demand data.

16. An apparatus as claimed in claim 15, wherein said predetermined request service device comprises an interface for transmitting video on demand data flow data from said video on demand data storage device to a device for using the video on demand data, and means for transmitting said video on demand data flow to said user device.

17. An apparatus as claimed in claim 15, further comprising a monitor for monitoring information about the video on demand data stored in said video on demand data storage device and for providing the information to said module.

18. An apparatus as claimed in claim 17, wherein said video on demand data storage device is operable to store video on demand data from a plurality of different titles, and said information identifies the titles for which video on demand data is stored in said storage device.

19. An apparatus as claimed in claim 7, further comprising a controller for controlling said service request device, said controller causing said device to service said request if said module determines that said device can service the request.

20. An apparatus as claimed in claim 7, further comprising said predetermined video on demand data request service device.

21. An apparatus as claimed in claim 7, wherein the apparatus is located in a network element, said network element having an ingress interface for receiving video on demand data from a plurality of video on demand titles and an egress interface having one or more ports, each for supplying video on demand data from a selected video on demand title received at said ingress interface to a device connected thereto.

22. An apparatus as claimed in claim 21, wherein said network element is adapted to receive IPTV titles from a network and includes means for providing a selected IPTV title to each of a plurality of subscriber equipment, and said predetermined request service device includes a storage device for storing video on demand data from at least one title, and for providing video on demand data to a subscriber equipment from said video on demand data storage device in response to a request and the determination made by said module.

23. An apparatus as claimed in claim 7, further comprising a device for including in a video on demand data request, an identifier recognizable by said selector that the request is to be processed by said module.

24. An apparatus comprising an interface for receiving requests for video on demand data, a selector operatively coupled to the interface for selecting from a plurality of video on demand data request service devices, and a device for servicing a particular request irrespective of the video on demand data request service device identified in the received request for servicing the request.

25. A method of processing video on demand data, comprising:
initiating a request for video on demand data from a first device;
transmitting the request for the video on demand data to a second device;
intercepting the transmission of the request for the video on demand data; and
redirecting the request for the video on demand data to a third device.

26. A method of processing video on demand data as claimed in claim 25, further comprising servicing the request for the video on demand data by the third device and transmitting the requested video on demand data to the first device.

27. A method of processing video on demand data as claimed in claim 25, further comprising determining that the third device has the requested data.

28. A method of processing video on demand data as claimed in claim 25, further comprising determining that the third device is able to service the request.

29. A method of processing video on demand data as claimed in claim 25, further comprising determining that the third device does not have the capacity to service the request, and redirecting the request for the video on demand data to a fourth device.

30. A method of processing video on demand data as claimed in claim 29, further comprising determining that the fourth device does not have the capacity to service the request, and redirecting the request for the video on demand data to the second device.

31. A method of processing video on demand data as claimed in claim 25, further comprising also directing the request for the video on demand data to the second device.

32. A method of processing video on demand data, comprising:
determining whether an operating status of a first device is satisfactory;
determining whether the first device supports a type of the video on demand data;
determining whether the first device has a sufficient capacity for a size of the video on demand data; and
directing a storage device to send the video on demand data to a second device when the operating status of the first device is not satisfactory, when the first device does not support the type of the video on demand data, and when the first device does not have the sufficient capacity for the size of the video on demand data.

33. A method of processing video on demand data as claimed in claim 32, wherein the video on demand data is a lost video on demand data packet.

34. A method of processing video on demand data as claimed in claim 32, wherein the video on demand data is a video on demand title.
